(19) United States
(12) Patent Application Publication
(10) Pub. No.: US 2010/0160470 A1
(43) Pub. Date: Jun. 24, 2010

(54) Flexible Polyurethane Foam

(76) Inventors: Theodore M. Smiecinski, Woodhaven, MI (US); Steven E. Wujcik, Ann Arbor, MI (US)

Correspondence Address: HOWARD & HOWARD ATTORNEYS PLLC;BASF SE, 450 West Fourth Street, Royal Oak, MI, 48067, US

(21) Appl. No.: 12/342,397

(22) Filed: Dec. 23, 2008

(51) Int. Cl. C08G 18/48

(52) U.S. Cl. 521/137

(57) ABSTRACT

A flexible polyurethane foam having a density of <100 kg/m³ comprises a reaction product of a polyisocyanate composition and an isocyanate-reactive composition. The polyisocyanate composition comprises a polymeric MDI component and a monomeric MDI component comprising 2,4′-MDI that is present in the monomeric MDI in an amount >35 parts by weight of the 2,4′-MDI based on 100 parts by weight of the monomeric MDI. The isocyanate-reactive composition comprises a primary hydroxyl-terminated graft polyether polyol and a second polyol different from the primary hydroxyl-terminated graft polyether polyol. The primary hydroxyl-terminated graft polyether polyol comprises a carrier polyol and particles of co-polymerized styrene and acrylonitrile. The carrier polyol has a weight average molecular weight of ≧3,500 g/mol.

### BACKGROUND OF THE INVENTION

1. Field of the Invention

The subject invention generally relates to a flexible polyurethane foam and a method of making the flexible polyurethane foam. More specifically, the subject invention relates to flexible polyurethane foam that exhibits flame retardance irrespective of an amount of flex fatigue of the flexible polyurethane foam.

2. Description of the Related Art

Polyurethane foams exhibit a wide range of stiffness, hardness, and density. One type of polyurethane foam, flexible polyurethane foam, is especially useful for providing cushioning, support, and comfort for furniture articles. For example, flexible polyurethane foam is often incorporated into furniture comfort articles, such as cushions and padding, and into furniture support articles, such as mattresses and pads.

Flexible polyurethane foams are typically flammable, especially when subjected to repeated compression and bending. The repeated compression and bending often results in compromise of the cellular structure of flexible polyurethane foams, generally referred to as flex fatigue. Flex fatigue allows for increased oxygen circulation within the foam, thereby increasing the flammability of the flexible polyurethane foam. Since flexible polyurethane foams are repeatedly subjected to compression and bending and thus, over time, experience flex fatigue when used in furniture comfort and support articles, United States Federal and state regulations currently proscribe flammability limits for flexible polyurethane foams. One such state regulation, California Technical Bulletin 117, specifies requirements, test procedures, and equipment for testing flame retardance of resilient filling materials, e.g. flexible polyurethane foams, in upholstered furniture.

Various approaches for producing flexible polyurethane foams exhibiting flame retardance and flexibility are known in the art. For example, many existing flexible polyurethane foams exhibiting flame retardance are produced via a reaction between toluene diisocyanate (TDI) and an isocyanate-reactive composition that typically includes one or more polyols. Until recently, TDI has been the most commonly-used isocyanate for producing flexible polyurethane foams having adequate flame retardance and flexibility, but has recently come under scrutiny as being less desirable than other available isocyanates.

Other approaches for producing flexible polyurethane foams rely on including flame retardant additives in the isocyanate-reactive composition. For example, flame retardant additives including minerals, such as asbestos; salts, such as hydroxymethyl phosponium salts; and synthetic materials, such as halocarbons may be included in the isocyanate-reactive composition. Still other existing approaches hinge on the selection of proper polyols and crosslinkers. For example, many existing flexible polyurethane foams are produced from polyether polyols having a weight average molecular weight of less than 3,500 g/mol and crosslinkers having a nominal functionality of greater than 3.

However, many of these existing flexible polyurethane foams suffer from one or more inadequacies, such as the use of undesirable raw materials and components, use of a high number of components, processing and molding difficulties, undesirable comfort and support properties, densities greater than 100 kg/m³, and flammability when experiencing flex fatigue.

Due to the inadequacies of existing flexible polyurethane foams, there remains an opportunity to provide a flexible polyurethane foam for use in furniture articles which does not suffer from the aforementioned inadequacies. Specifically, there remains an opportunity to provide a flexible polyurethane foam that exhibits flame retardance irrespective of an amount of flex fatigue experienced by the flexible polyurethane foam while eliminating certain undesirable components and maintaining desirable comfort and support properties.

### SUMMARY OF THE INVENTION AND ADVANTAGES

The subject invention provides a flexible polyurethane foam having a density of less than 100 kg/m³. The flexible polyurethane foam comprises a reaction product of a polyisocyanate composition and an isocyanate-reactive composition. The polyisocyanate composition comprises a polymeric diphenylmethane diisocyanate (MDI) component and a monomeric diphenylmethane diisocyanate (MDI) component comprising 2,4′-MDI. The 2,4′-MDI is present in the monomeric MDI component in an amount greater than 35 parts by weight of the 2,4′-MDI based on 100 parts by weight of the monomeric MDI component.

The isocyanate-reactive composition comprises a primary hydroxyl-terminated graft polyether polyol and a second polyol different from the primary hydroxyl-terminated graft polyether polyol. The primary hydroxyl-terminated graft polyether polyol comprises a carrier polyol and particles of co-polymerized styrene and acrylonitrile dispersed in the carrier polyol. The carrier polyol has a weight average molecular weight of greater than or equal to 3,500 g/mol.

The subject invention also provides a method of forming the flexible polyurethane foam. The method comprises the steps of providing the polyisocyanate composition, providing the isocyanate-reactive composition, and reacting the polyisocyanate composition with the isocyanate-reactive composition to form the flexible polyurethane foam.

The flexible polyurethane foam exhibits flame retardance under flammability tests according to California Technical Bulletin 117 regulations irrespective of an amount of flex fatigue of the flexible polyurethane foam. Additionally, the flexible polyurethane foam of the present invention has a density of less than 100 kg/m³, exhibits excellent comfort and support properties, and eliminates the need to use toluene diisocyanate (TDI) to achieve adequate flame retardance.

### DETAILED DESCRIPTION OF THE INVENTION

The present invention includes a flexible polyurethane foam and a method of forming the flexible polyurethane foam. The flexible polyurethane foam is typically used to provide cushioning, support, and comfort in furniture articles, such as cushions, padding, and mattresses. However, it is to be appreciated that the flexible polyurethane foam of the present invention can have applications beyond furniture articles, such as noise, vibration, and harshness (NVH) reduction articles for vehicles.

As used herein, the terminology “flexible polyurethane foam” denotes a class of polyurethane foam and stands in contrast to rigid polyurethane foam. Generally, as known in the art, polyurethane foams may be categorized as flexible polyurethane foams, having a tensile stress at 10% compression, i.e., compressive strength according to test method DIN 53421, of less than about 15 KPa; semi-rigid polyurethane foams, having a tensile stress at 10% compression of from about 15 to 80 KPa; and rigid polyurethane foams, having a tensile stress at 10% compression of greater than 80 KPa. Although both flexible polyurethane foams and rigid polyurethane foams are formed via a reaction of a polyol and an isocyanate, the terminology “flexible polyurethane foam” generally describes foam having less stiffness than rigid polyurethane foam. In particular, flexible polyurethane foam is a flexible cellular product, i.e., a cellular, organic, polymeric material that will not rupture when a specimen 200 mm by 25 mm by 25 mm is bent around a 25-mm diameter mandrel at a uniform rate of 1 lap in 5 seconds at a temperature between 18 and 29° C., as defined by ASTM D3574-03. Further, as known in the art, polyol selection impacts the stiffness of polyurethane foams. That is, flexible polyurethane foams are typically produced from polyols having weight average molecular weights from 1,000 to 10,000 g/mol and hydroxyl numbers from 18 to 115 mg KOH/g. In contrast, rigid polyurethane foams are typically produced from polyols having weight average molecular weights from 250 to 700 g/mol and hydroxyl numbers from 300 to 700 mg KOH/g. Moreover, flexible polyurethane foams generally include more urethane linkages as compared to rigid polyurethane foams, whereas rigid polyurethane foams may include more isocyanurate linkages as compared to flexible polyurethane foams. Further, flexible polyurethane foams are typically produced from polyols having low-functionality (f) initiators, i.e., f<4, such as dipropylene glycol (f=2) or glycerine (f=3). By comparison, rigid polyurethane foams are typically produced from polyols having high-functionality initiators, i.e., f≧4, such as Mannich bases (f=4), toluenediamine (f=4), sorbitol (f=6), or sucrose (f=8). Additionally, as known in the art, flexible polyurethane foams are typically produced from glycerine-based polyether polyols, whereas rigid polyurethane foams are typically produced from polyfunctional polyols that create a three-dimensional cross-linked cellular structure, thereby increasing the stiffness of the rigid polyurethane foam. Finally, although both flexible polyurethane foams and rigid polyurethane foams include cellular structures, flexible polyurethane foams typically include more open cell walls, i.e., voids, which allow air to pass through the flexible polyurethane foam when force is applied as compared to rigid polyurethane foams. As such, flexible polyurethane foams typically recover shape after compression. In contrast, rigid polyurethane foams typically include more closed cell walls, which restrict air flow through the rigid polyurethane foam when force is applied. Therefore, flexible polyurethane foams are typically useful for cushioning and support applications, e.g. furniture comfort and support articles, whereas rigid polyurethane foams are typically useful for applications requiring thermal insulation, e.g. appliances and building panels.

The flexible polyurethane foam of the present invention comprises a reaction product of a polyisocyanate composition and an isocyanate-reactive composition. It is to be appreciated that the terminology polyisocyanate composition as used herein is to be construed as including free polyisocyanates. It is also to be appreciated that the terminology polyisocyanate composition as used herein typically excludes prepolymers. Said differently, prepolymers, e.g., polyols in polyisocyanate, are typically not formed from a reaction product of the isocyanate-reactive composition with excess polyisocyanate.

The polyisocyanate composition comprises a polymeric diphenylmethane diisocyanate (MDI) component. The polymeric MDI component is typically present in the polyisocyanate composition to provide reactive groups, i.e., NCO groups, during a flexible polyurethane foaming reaction, as set forth in more detail below. The polymeric MDI component is typically a mixture of oligomeric diphenylmethane diisocyanates, i.e., a mixture of MDI and its dimer and/or trimer. The polymeric MDI component comprises a crude MDI having three or more benzene rings including NCO groups. The polymeric MDI is typically obtained through the condensation of aniline and formaldehyde in the presence of an acid catalyst, followed by phosgenation and distillation of a resulting polymeric amine mixture. The polymeric MDI component is typically present in the polyisocyanate composition in an amount of from 1 to 20, more typically 2 to 10 parts by weight based on 100 parts by weight of the polyisocyanate composition.

The polyisocyanate composition further comprises a monomeric MDI component comprising 2,4′-MDI. As used herein, the terminology monomeric MDI denotes a component comprising the MDI isomers, such as 2,4′-MDI, 4,4′-MDI, or 2,2′-MDI. As compared to 4,4′-MDI and 2,2′-MDI, 2,4′-MDI is an asymmetrical molecule and provides two NCO groups of differing reactivities. Therefore, without intending to be limited by theory, the 2,4′-MDI is typically present in the polyisocyanate composition to optimize flexible polyurethane foaming reaction parameters such as stability and curing time of the flexible polyurethane foam. The 2,4′-MDI is present in the monomeric MDI component in an amount greater than 10 parts by weight of the 2,4′-MDI based on 100 parts by weight of the monomeric MDI component. The 2,4′-MDI is more typically present in the monomeric MDI component in an amount of greater than 35, most typically greater than 65 parts by weight based on 100 parts by weight of the monomeric MDI component.

The monomeric MDI component may further include 2,2′-MDI and 4,4′-MDI. It is preferred that 2,2′-MDI is either not present at all in the monomeric MDI component or is present in small amounts, i.e., typically from 0 to 2, more typically 0.1 to 1.5 parts by weight based on 100 parts by weight of the monomeric MDI component. The 4,4′-MDI is typically present in the monomeric MDI component in an amount of from 0 to 65, more typically 20 to 55, and most typically 30 to 35 parts by weight based on 100 parts by weight of the monomeric MDI component.

The monomeric MDI component is typically present in the polyisocyanate composition in an amount of from 80 to 99, more typically 90 to 98 parts by weight based on 100 parts by weight of the polyisocyanate composition.

Notably, the polyisocyanate composition is free from flame retardant additives such as, but not limited to, minerals, such as asbestos; salts, such as hydroxymethyl phosponium salts; phosphorus-containing compounds; halogenated flame retardant additives; and synthetic materials, such as halocarbons. In addition, the polyisocyanate composition is typically free from melamine, which is also utilized as a flame retardant additive in particular applications. Since flame retardant additives are typically expensive, the flexible polyurethane foam of the present invention comprising the reaction product of the polyisocyanate composition and the isocyanate-reactive composition is cost effective to manufacture. The polyisocyanate composition of the present invention is typically free from toluene diisocyanate (TDI), specifically 2,4′-TDI and 2,6′-TDI. Since TDI is typically less desirable for humans and the environment than MDI, the polyisocyanate composition of the present invention exhibits more acceptable processing characteristics as compared to existing polyisocyanate compositions comprising TDI. Yet, the flexible polyurethane foam of the present invention exhibits flame retardance under flammability tests according to California Technical Bulletin 117 regulations irrespective of an amount of flex fatigue of the flexible polyurethane foam, as set forth in further detail below.

Without intending to be limited by theory, it is believed that the polyisocyanate composition, comprising the polymeric MDI component and the monomeric MDI component, contributes to the excellent flame retardance of the flexible polyurethane foam because the monomeric MDI component and the polymeric MDI component change the melt characteristics of the flexible polyurethane foam. For example, it is believed that the monomeric MDI component and the polymeric MDI component provide additional char formation during burning for the flexible polyurethane foam. Additional char formation typically forms a stable, carbonaceous barrier which prevents a flam from accessing the underlying flexible polyurethane foam. More specifically, it is believed that the polyisocyanate composition affects the crystallinity of the flexible polyurethane foam so that, when exposed to a flame, the flexible polyurethane foam melts away from flame rather than remaining in the flame. Stated differently, the polyisocyanate composition provides the flexible polyurethane foams of the present invention with a continuous crystalline matrix that provides a charred barrier to flame propagation. Additionally, it is believed that the polyisocyanate composition minimizes vapor formation when the flexible polyurethane foam of the present invention is exposed to heat. Since flame propagation requires a vapor phase, the flexible polyurethane foam of the present invention exhibits excellent flame retardance under flammability tests according to California Technical Bulletin 117.

The polyisocyanate composition typically has NCO groups present in the polyisocyanate composition in an amount of about 33 parts by weight based on 100 parts by weight of the polyisocyanate composition. Further, the polyisocyanate composition typically has a viscosity of 17 cps at 25° C. and an average functionality of about 2.1. The polyisocyanate composition typically has a flash point of 200° C. and a density of 1.20 g/cm³ at 25° C., which allows for processing efficiencies such as ease of component mixing, thereby contributing to the cost effectiveness of producing the flexible polyurethane foam. A suitable polyisocyanate composition for purposes of the present invention includes Lupranate® 280 isocyanate commercially available from BASF Corporation of Florham Park, N.J.

The isocyanate-reactive composition comprises a primary hydroxyl-terminated graft polyether polyol comprising a carrier polyol and particles of co-polymerized styrene and acrylonitrile, wherein the particles of co-polymerized styrene and acrylonitrile are dispersed in the carrier polyol, as set forth in more detail below. The primary hydroxyl-terminated graft polyether polyol is formed from a low-functionality, i.e., f<4, initiator, e.g. glycerine (f=3) or trimethylol propane (f=3). The primary hydroxyl-terminated graft polyether polyol typically has a functionality of from 2 to 4, more typically from 2.5 to 3. The low-functionality initiator undergoes an oxyalkylation reaction with propylene oxide and ethylene oxide to provide primary hydroxyl group-termination, e.g., an ethylene oxide cap. The primary hydroxyl-terminated graft polyether polyol typically comprises primary hydroxyl groups to increase the polarity and reactivity of the primary hydroxyl-terminated graft polyether polyol. The ethylene oxide caps are typically present in the primary hydroxyl-terminated graft polyether polyol in an amount of from 10 to 90, more typically 15 to 60 parts by weight based on 100 parts by weight of the primary hydroxyl-terminated graft polyether polyol.

Further, as used herein, the terminology “graft polyether polyol” denotes dispersed polymer solids chemically grafted to the carrier polyol. The dispersed polymer solids are combinations of styrenes and ethylenically unsaturated nitriles. More specifically, the primary hydroxyl-terminated graft polyether polyol of the present invention comprises dispersed particles of co-polymerized styrene and acrylonitrile.

The carrier polyol may be any known primary hydroxyl-terminated polyether polyol in the art and preferably serves as a continuous phase for the dispersed co-polymerized styrene and acrylonitrile particles. That is, the co-polymerized styrene and acrylonitrile particles are dispersed in the carrier polyol to form a dispersion, i.e., to form the primary hydroxyl-terminated graft polyether polyol. The carrier polyol typically has a number average molecular weight of greater than or equal to 3,500, more typically greater than or equal to 4,000, and most typically greater than or equal to 5,000 g/mol. The carrier polyol typically has the aforementioned weight average molecular weight so as to provide the flexible polyurethane foam with flexibility and a density of less than 100 kg/m³. That is, the aforementioned weight average molecular weight of the carrier polyol contributes to the flexibility of the flexible polyurethane foam of the present invention, but also allows for the formation of the flexible polyurethane foam having a density of less than 100 kg/m³. The weight average molecular weight of the carrier polyol typically provides randomly-sized, irregular-shaped cells, e.g., cells that differ in both size and shape from neighboring cells, in the flexible polyurethane foam that allow the flexible polyurethane foam to recover shape after compression.

The particles of co-polymerized styrene and acrylonitrile are dispersed in the carrier polyol in an amount of from 5 to 65, typically from 10 to 45, more typically from 25 to 35, and most typically 32 parts by weight of particles based on 100 parts by weight of the carrier polyol. An example of a carrier polyol having the particles of co-polymerized styrene and acrylonitrile dispersed therein in an amount of 32 parts by weight based on 100 parts by weight of the carrier polyol is Pluracol® 4830, commercially available from BASF Corporation of Florham Park, N.J.

Without intending to be limited by theory, the primary hydroxyl-terminated graft polyether polyol is typically present in the isocyanate-reactive composition to provide the flexible polyurethane foam with an optimal cross-sectional density and to adjust the solids level of the flexible polyurethane foam. The primary hydroxyl-terminated graft polyether also typically contributes to the processability and hardness of the flexible polyurethane foam. The primary hydroxyl-terminated graft polyether polyol also allows for optimal cell opening during formation of the flexible polyurethane foam without having any adverse effects on the resilience of the flexible polyurethane foam. As such, the primary hydroxyl-terminated graft polyether polyol is typically referred to in the art as a high-resilient (HR) polyol because the flexible polyurethane foam formed therefrom has excellent resilient properties. HR polyols also have excellent processability and reduced cure time when forming the flexible polyurethane foam as compared to secondary hydroxyl germinated polyether polyols. Further, it is believed that the primary hydroxyl-terminated graft polyether polyol contributes to the flame retardance of the flexible polyurethane foam of the present invention. The primary hydroxyl-terminated graft polyether polyol is typically present in the isocyanate-reactive composition in an amount of from 5 to 95, more typically from 10 to 90, and most typically from 20 to 80 parts by weight based on 100 parts of total polyol present in the isocyanate-reactive composition. Additionally, the primary hydroxyl-terminated graft polyether polyol typically has hydroxyl number of from 10 to 60, more typically from 20 to 40 mg KOH/g.

Further, the primary hydroxyl-terminated graft polyether polyol typically has a viscosity of from 1,000 to 7,000 centipoise at 25° C., which allows for processing efficiencies such as ease of component mixing, thereby contributing to the cost effectiveness of producing the flexible polyurethane foam. A suitable primary hydroxyl-terminated graft polyether polyol for purposes of the present invention is Pluracol® 4830, commercially available from BASF Corporation of Florham Park, N.J.

The isocyanate-reactive composition further comprises a second polyol different from the primary hydroxyl-terminated graft polyether polyol. The second polyol is typically a conventional polyether polyol. As used herein, the terminology “conventional polyether polyol” denotes a non-graft polyether polyol. The second polyol is formed from a low-functionality, i.e., f<4, triol glycol initiator, such as tripropylene glycol, trimethylol propane, and/or glycerin. Therefore, the second polyol typically has a functionality of less than or equal to 3.5, more typically of from 2.2 to 3.2. The low-functionality initiator undergoes an oxyalkylation reaction with propylene oxide to provide a core of the second polyol and with ethylene oxide to provide primary hydroxyl group-termination, e.g. ethylene oxide caps. The second polyol typically comprises primary hydroxyl groups to increase the polarity and reactivity of the second polyol. When utilized, the ethylene oxide caps are typically present in the second polyol in an amount of from greater than 0 to 60, more typically from 5 to 25 parts by weight based on 100 parts by weight of the second polyol.

Without intending to be limited by theory, the second polyol is typically present in the isocyanate-reactive composition to optimize the stability of the flexible polyurethane foam and to provide the flexible polyurethane foam with a density of less than 100 kg/m³. Further, it is believed that the second polyol contributes to the flame retardance of the flexible polyurethane foam of the present invention.

The second polyol typically has a weight average molecular weight of greater than or equal to 1,000, more typically greater than or equal to 3,500, and most typically greater than or equal to 4,000 g/mol, and a hydroxyl number of from 15 to 45, more typically from 20 to 40 mg KOH/g. The second polyol typically has the aforementioned weight average molecular weight so as to provide the flexible polyurethane foam with flexibility and a density of less than 100 kg/m³. That is, the aforementioned weight average molecular weight of the second polyol contributes to the flexibility of the flexible polyurethane foam of the present invention, but also allows for the formation of the flexible polyurethane foam having a density of less than 100 kg/m³. The aforementioned weight average molecular weight of the second polyol also softens the flexible polyurethane foam of the present invention and provides excellent comfort and support properties. The weight average molecular weight of the second polyol also typically provides randomly-sized, irregular-shaped cells, e.g., cells that differ in both size and shape from neighboring cells, in the flexible polyurethane foam that allow the flexible polyurethane foam to recover shape after compression.

The second polyol also typically has a viscosity of from 500 to 2,000 centipoise at 25° C., which allows for processing efficiencies such as ease of component mixing, thereby contributing to the cost effectiveness of producing the flexible polyurethane foam. The second polyol is typically present in the isocyanate-reactive composition in an amount from 5 to 95, more typically 20 to 80 parts by weight based on 100 parts by weight of the isocyanate-reactive composition. Suitable second polyols for purposes of the present invention include, but are not limited to, Pluracol® 945, Pluracol® 2100, and Pluracol® 2090, each of which is commercially available from BASF Corporation of Florham Park, N.J.

The isocyanate-reactive composition further comprises a crosslinker having a nominal functionality of less than 4. The crosslinker generally allows phase separation between copolymer segments of the flexible polyurethane foam. That is, the flexible polyurethane foam typically comprises both rigid urea copolymer segments and soft polyol copolymer segments. The crosslinker typically chemically and physically links the rigid urea copolymer segments to the soft polyol copolymer segments. Therefore, the crosslinker is typically present in the isocyanate-reactive composition to modify the hardness, increase stability, and reduce shrinkage of the flexible polyurethane foam. The crosslinker is typically present in the isocyanate-reactive composition in an amount of from 0.01 to 4, more typically 1 to 3 parts by weight based on 100 parts by weight of total polyol present in the isocyanate-reactive composition.

Suitable crosslinkers include any crosslinker known in the art, such as diethanolamine in water. The diethanolamine is typically present in the crosslinker in an amount of about 85 parts by weight based on 100 parts by weight of the crosslinker. A specific example of a suitable crosslinker for the purposes of the present invention is Dabco™ DEOA-LF commercially available from Air Products and Chemicals, Inc. of Allentown, Pa.

The isocyanate-reactive composition typically further comprises a catalyst component. The catalyst component is typically present in the isocyanate-reactive composition to catalyze the flexible polyurethane foaming reaction between the polyisocyanate composition and the isocyanate-reactive composition. It is to be appreciated that the catalyst component is typically not consumed to form the reaction product of the polyisocyanate composition and the isocyanate-reactive composition. That is, the catalyst component typically participates in, but is not consumed by the flexible polyurethane foaming reaction. The catalyst component is typically present in the isocyanate-reactive composition in an amount of from 0.01 to 1, more typically from 0.05 to 0.50 parts by weight based on 100 parts by weight of total polyol present in the isocyanate-reactive composition. The catalyst component may include any suitable catalyst or mixtures of catalysts known in the art. Examples of suitable catalysts include, but are not limited to, gelation catalysts, e.g. crystalline catalysts in dipropylene glycol; blowing catalysts, e.g. bis(dimethylaminoethyl)ether in dipropylene glycol; and tin catalysts, e.g. tin octoate. A suitable catalyst component for purposes of the present invention is Dabco™ 33LV commercially available from Air Products and Chemicals of Allentown, Pa.

The isocyanate-reactive composition may further comprise an additive component. The additive component is typically selected from the group of surfactants, blowing agents, blocking agents, dyes, pigments, diluents, solvents, specialized functional additives such as antioxidants, ultraviolet stabilizers, biocides, adhesion promoters, antistatic agents, mold release agents, fragrances, and combinations of the group. Suitable additive components comprise any known dye, pigment, diluent, solvent, and specialized functional additive known in the art. When utilized, the additive component is typically present in the isocyanate-reactive composition in an amount of from greater than 0 to 15, more typically from 1 to 10 parts by weight based on 100 parts of total polyol present in the isocyanate-reactive composition.

A surfactant is typically present in the additive component of the isocyanate-reactive composition to control cell structure of the flexible polyurethane foam and to improve miscibility of components and flexible polyurethane foam stability. Suitable surfactants include any surfactant known in the art, such as silicones and nonylphenol ethoxylates. Typically, the surfactant is a silicone. More specifically, the silicone is typically a polydimethylsiloxane-polyoxyalkylene block copolymer. The surfactant may be selected according to the reactivity of the primary hydroxyl-terminated graft polyether polyol and the second polyol. The surfactant is typically present in the isocyanate-reactive composition in an amount of from 0.5 to 2 parts by weight based on 100 parts by weight of total polyol present in the isocyanate-reactive composition. A specific example of a surfactant for the purposes of the present invention is U-2000 silicone, commercially available from Momentive Performance Materials of Friendly, W.V.

A blowing agent is typically present in the additive component of the isocyanate-reactive composition to facilitate the formation of the flexible polyurethane foam. That is, as is known in the art, during the flexible polyurethane foaming reaction between the polyisocyanate composition and the isocyanate-reactive composition, the blowing agent promotes the release of a blowing gas which forms cell voids in the flexible polyurethane foam. The blowing agent may be a physical blowing agent or a chemical blowing agent.

The terminology physical blowing agent refers to blowing agents that do not chemically react with the polyisocyanate composition and/or the isocyanate-reactive composition to provide the blowing gas. The physical blowing agent can be a gas or liquid. The liquid physical blowing agent typically evaporates into a gas when heated, and typically returns to a liquid when cooled. The physical blowing agent typically reduces the thermal conductivity of the flexible polyurethane foam. Suitable physical blowing agents for the purposes of the subject invention may include liquid CO₂, acetone, and combinations thereof. The most typical physical blowing agents typically have a zero ozone depletion potential.

The terminology chemical blowing agent refers to blowing agents which chemically react with the polyisocyanate composition or with other components to release a gas for foaming. Examples of chemical blowing agents that are suitable for the purposes of the subject invention include formic acid, water, and combinations thereof.

The blowing agent is typically present in the isocyanate-reactive composition in an amount of from 0.5 to 20 parts by weight based on 100 parts by weight of total polyol present in the isocyanate-reactive composition. A specific example of a blowing agent that is suitable for the purposes of the present invention is water.

The additive component of the isocyanate-reactive composition may also include a blocking agent. The blocking agent is typically present in the additive component of the isocyanate-reactive composition to delay cream time and increase cure time of the flexible polyurethane foam. Suitable blocking agents include any blocking agent known in the art. Typically, the blocking agent is a polymeric acid, i.e., a polymer with repeating units and multiple acid-functional groups. One skilled in the art typically selects the blocking agent according to the reactivity of the polyisocyanate composition. The blocking agent is typically present in the isocyanate-reactive composition in an amount of from 0.05 to 1.5 parts by weight based on 100 parts by weight of total polyol present in the isocyanate-reactive composition. A specific example of a surfactant for the purposes of the present invention is Dabco™ BA100 commercially available from Air Products and Chemicals, Inc. of Allentown, Pa.

Moreover, the flexible polyurethane foam of the present invention is typically free from flame retardant additives. Unexpectedly, even without inclusion of flame retardant additives, the flexible polyurethane foam exhibits flame retardance under flammability tests according to California Technical Bulletin 117 regulations irrespective of an amount of flex fatigue of the flexible polyurethane foam. That is, even when experiencing the effects of flex fatigue, such as compromised cellular structure, which allows for increased oxygen circulation within the flexible polyurethane foam and typically increases the flammability of flexible polyurethane foam, the flexible polyurethane foam of the present invention unexpectedly exhibits flame retardance irrespective of an amount of flex fatigue of the flexible polyurethane foam. It is believed that the inclusion of the polymeric MDI and the monomeric MDI in the quantities set forth above, rather than TDI which is conventionally used to impart flame retardance to flexible polyurethane foams, in combination with the primary hydroxyl-terminated graft polyether polyol and the second polyol, both having the weight average molecular weights set forth above, unexpectedly provides the flexible polyurethane foam with flame retardance irrespective of an amount of flex fatigue. Further, it is believed that the inclusion of the polymeric MDI and the monomeric MDI in the quantities set forth above, in combination with the primary hydroxyl-terminated graft polyether polyol and the second polyol also unexpectedly provides the flexible polyurethane foam with flexibility and a density of less than 100 kg/m³. In particular, as set forth above, without intending to be limited by theory, it is believed that the polyisocyanate composition, comprising the polymeric MDI component and the monomeric MDI component, contributes to the excellent flame retardance of the flexible polyurethane foam because the monomeric MDI component and the polymeric MDI component change the melt characteristics of the flexible polyurethane foam. More specifically, it is believed that the polyisocyanate composition provides the flexible polyurethane foams of the present invention with a continuous crystalline matrix that provides a charred barrier to flame propagation. Additionally, it is believed that the polyisocyanate composition minimizes vapor formation when the flexible polyurethane foam of the present invention is exposed to heat. Since flame propagation requires a vapor phase, the flexible polyurethane foam of the present invention exhibits excellent flame retardance under flammability tests according to California Technical Bulletin 117.

The method of forming the flexible polyurethane foam comprises the steps of providing the polyisocyanate composition, providing the isocyanate-reactive composition, and reacting the polyisocyanate composition with the isocyanate-reactive composition to form the flexible polyurethane foam. The method may further comprise the steps of providing the catalyst component and reacting the polyisocyanate composition with the isocyanate-reactive composition in the presence of the catalyst component to form the flexible polyurethane foam.

The polyisocyanate composition and the isocyanate-reactive composition are typically reacted at an isocyanate index of greater than or equal to 0.7, more typically greater than or equal to 0.9. The terminology isocyanate index is defined as the ratio of NCO groups in the polyisocyanate composition to hydroxyl groups in the isocyanate-reactive composition. The flexible polyurethane foam of the present invention may be formed by mixing the polyisocyanate composition and the isocyanate-reactive composition to form a mixture at room temperature or at slightly elevated temperatures, e.g. 15 to 30° C. It certain embodiments in which the flexible polyurethane foam is formed in a mold, it is to be appreciated that the polyisocyanate composition and the isocyanate-reactive composition may be mixed to form the mixture prior to disposing the mixture in the mold. For example, the mixture may be poured into an open mold or the mixture may be injected into a closed mold. Alternatively, the polyisocyanate composition and the isocyanate-reactive composition may be mixed to form the mixture within the mold. In this embodiment, upon completion of the flexible polyurethane foaming reaction, the flexible polyurethane foam takes the shape of the mold. The flexible polyurethane foam may be formed in, for example, low pressure molding machines, low pressure slabstock conveyor systems, high pressure molding machines, including multi-component machines, high pressure slabstock conveyor systems, and/or by hand mixing.

In certain embodiments, the flexible polyurethane foam is formed or disposed in a slabstock conveyor system, which typically forms flexible polyurethane foam having an elongated rectangular or circular shape. It is particularly advantageous to form the flexible polyurethane foam in slabstock conveyor systems due to the excellent processability of the flexible polyurethane foam. As known in the art, slabstock conveyor systems typically include mechanical mixing head for mixing individual components, a trough for containing a flexible polyurethane foaming reaction, a moving conveyor for flexible polyurethane foam rise and cure, and a fallplate unit for leading expanding flexible polyurethane foam onto the moving conveyor.

The flexible polyurethane foam of the present invention has a density of less than 100 kg/m³. Typically, the flexible polyurethane foam has a density of greater than or equal to 10 and less than 100, more typically greater than or equal to 10 and less than or equal to 65, and most typically greater than or equal to 15 and less than or equal to 45 kg/m³. Unexpectedly, despite having a density of less than 100 kg/m³ and being free from flame retardant additives, the flexible polyurethane foam exhibits flame retardance under flammability tests according to California Technical Bulletin 117 regulations irrespective of an amount of flex fatigue of the flexible polyurethane foam. That is, the flexible polyurethane foam of the present invention typically exhibits excellent flame retardance and satisfies requirements of the Vertical Open Flame test and the Cigarette Resistance and Smoldering Screening Tests according to the test procedures as specified in Section A and Section D of California Technical Bulletin 117, even after being subjected to repeated load cycling to induce flex fatigue.

More specifically, the Vertical Open Flame test measures an amount of time that the flexible polyurethane foam exhibits a flame after an open flame is removed, i.e., an afterflame time. The results of the Vertical Open Flame test are recorded as a char length, i.e., a distance from a flame-exposed end of the flexible polyurethane foam to an upper edge of a resulting void area, along with the afterflame time. The Cigarette Resistance and Smoldering Screening tests measure a resistance of the flexible polyurethane foam to burning and smoldering.

Unexpectedly, the flexible polyurethane foam of the present invention typically exhibits an afterflame time of less than five, more typically less than three, most typically less than one, seconds. That is, the flexible polyurethane foam does not continue to flame for longer than five seconds after the open flame is removed, thereby minimizing risks from burn injuries when the flexible polyurethane foam is used in furniture comfort and support articles. Further, the flexible polyurethane foam unexpectedly has a char length, i.e., the distance from an end of the flexible polyurethane foam which is exposed to the flame to an upper edge of a void area of the flexible polyurethane foam, of less than six inches, more typically less than three inches. That is, the distance from the end of the flexible polyurethane foam that is exposed to flame to an upper edge of a resulting void area is less than six inches. Thus, the flexible polyurethane foam minimizes risks from burn injuries caused by furniture articles exposed to open flames, such as candles, matches, or cigarette lighters. Additionally, the flexible polyurethane foam typically retains greater than 80, more typically greater than 90, most typically greater than 99, percent of its weight after smoldering when not experiencing flex fatigue. Unexpectedly, after experiencing flex fatigue, the flexible polyurethane foam retains greater than 80 percent of its weight. That is, the flexible polyurethane foam typically retains greater than 80 percent of its pre-smoldering weight, even after experiencing flex fatigue. Since flex fatigue compromises the cellular structure of flexible polyurethane foams, and allows for increased oxygen circulation within the foam, flex fatigue usually increases the flammability of flexible polyurethane foam from sources such as a smoldering cigarette or open flames. However, the flexible polyurethane foam of the present invention unexpectedly exhibits flame retardance irrespective of an amount of flex fatigue of the flexible polyurethane foam.

Moreover, the flexible polyurethane foam of the present invention not only exhibits flame retardance irrespective of an amount of flex fatigue of the flexible polyurethane foam, but also exhibits excellent comfort and support properties, e.g. flexibility and stability.

In particular, the flexible polyurethane foam of the present invention typically exhibits a tensile strength of greater than 10 psi, an elongation of greater than 100 percent, and a tear strength of greater than 1.0 ppi as measured in accordance with ASTM D3574. Tensile strength, tear strength, and elongation properties describe the ability of the flexible polyurethane foam to withstand handling during manufacturing or assembly operations. Therefore, in light of the excellent aforementioned tensile strength, tear strength, and elongation values, the flexible polyurethane foam is cost effective to manufacture.

The flexible polyurethane foam typically exhibits a resilience of greater than 45 percent. Resilience measures a propensity of the flexible polyurethane foam to “bounce back” or rebound after a compressive force is removed, and is an especially important support property for flexible polyurethane foams used in furniture articles. Resilience of the flexible polyurethane foam is determined by dropping a steel ball from a reference height onto the flexible polyurethane foam and measuring a peak height of ball rebound. The resilience is expressed in percent of the reference height.

The flexible polyurethane foam also typically exhibits an ability to withstand wear and tear, i.e. flex fatigue, as measured according to ASTM D4065. The ability to withstand wear and tear is measured by repeatedly compressing the flexible polyurethane foam and measuring a change in 40% indentation force deflection (IFD). Forty percent IFD is defined as the amount of force in pounds required to indent a 50 in², round indentor foot into the flexible polyurethane foam a distance of 40% of the thickness of the flexible polyurethane foam. To measure flex fatigue, an original height of the flexible polyurethane foam is measured and an amount of force corresponding to 40% IFD is determined. The flexible polyurethane foam is then subjected to repeated pounding for cycles at the 40% IFD force. After pounding, the height of the flexible polyurethane foam is then re-measured and a percentage of height loss is calculated. The percentage of height loss of the flexible polyurethane foam is typically less than 10 percent.

Additionally, an amount of force required to achieve 25% IFD of the flexible polyurethane foam is typically from 5 to 125 lb/50 in². A support factor for the flexible polyurethane foam, i.e., an amount of force required to achieve 65% IFD divided by the amount of force required to achieve 25% IFD, is typically greater than 2.0. Therefore, as set forth above, the flexible polyurethane foam exhibits excellent comfort and support properties when used in furniture articles.

### EXAMPLES

The following examples are intended to illustrate the invention and are not to be viewed in any way as limiting to the scope of the invention.

A flexible polyurethane foam is formed according to the method as set forth above. More specifically, the flexible polyurethane foam is formed from the specific polyisocyanate composition and isocyanate-reactive composition of the formulations listed in Table 1. Except as where indicated, the amounts in Table 1 are listed in parts by weight based on 100 parts by weight of total polyol in the flexible polyurethane foam formulation.

TABLE 1
Flexible Polyurethane Foam Formulations

| | | | Comp. | Comp. | Comp. |
|---|---|---|---|---|---|
| Component | Ex. 1 | Ex. 2 | Ex. 3 | Ex. 4 | Ex. 5 |
| Polyisocyanate | | | | | |
| composition | | | | | |
| Isocyanate A | 56.3 | 56.3 | — | — | — |
| Isocyanate B | — | — | 40.3 | 40.0 | 35.1 |
| Isocyanate-reactive | | | | | |
| composition | | | | | |
| Polyol C | 44.0 | 44.0 | 65.0 | 65.0 | — |
| Polyol D | 56.0 | 56.0 | 35.0 | — | 72.0 |
| Polyol E | — | — | — | 35.0 | — |
| Polyol F | — | — | — | — | 28.0 |
| Crosslinker G | 2.0 | 2.0 | 1.7 | 1.8 | 1.4 |
| Crosslinker H | — | — | — | — | 1.5 |
| Solvent J | 5.0 | 5.0 | — | — | — |
| Catalyst Component | | | | | |
| Catalyst K | 0.075 | 0.075 | 0.070 | 0.080 | 0.040 |
| Catalyst L | 0.075 | 0.075 | 0.040 | 0.040 | 0.030 |
| Catalyst M | 0.125 | 0.125 | — | — | 0.330 |
| Catalyst N | — | — | 0.040 | 0.050 | — |
| Additive Component | | | | | |
| Surfactant P | 1.0 | 1.0 | 1.2 | 1.3 | 1.0 |
| Blocking Agent Q | 0.10 | 0.10 | — | — | — |
| Water | 3.15 | 3.15 | 3.15 | 3.15 | 2.61 |
| (total = added + present | | | | | |
| in polyols) | | | | | |
| Flame Retardant | — | 3.0 | 3.0 | 3.0 | — |
| Additive R | | | | | |
| Isocyanate Index | 0.97 | 0.97 | 1.05 | 1.05 | 1.02 |
| % Isocyanate A | 100 | 100 | — | — | — |
| % Isocyanate B | — | — | 100 | 100 | 100 |

Isocyanate A is a polyisocyanate composition comprising a polymeric diphenylmethane diisocyanate (MDI) component and a monomeric diphenylmethane diisocyanate (MDI) component comprising 2,4′-MDI. The 2,4′-MDI is present in the monomeric MDI component in an amount greater than 35 parts by weight of the 2,4′-MDI based on 100 parts by weight of the monomeric MDI component. The polymeric MDI component is present in the polyisocyanate composition in an amount of less than 40 parts by weight based on 100 parts by weight of the polyisocyanate composition.

Isocyanate B is toluene diisocyanate (TDI).

Polyol C is a primary hydroxyl-terminated graft polyether polyol comprising Carrier Polyol Cl and particles of co-polymerized styrene and acrylonitrile. The particles of co-polymerized styrene and acrylonitrile are dispersed in Carrier Polyol Cl in an amount of about 30 parts by weight of particles based on 100 parts by weight of Carrier Polyol Cl. Carrier Polyol Cl has a weight average molecular weight of about 5,000 g/mol. The primary hydroxyl-terminated graft polyether polyol is a glycerine-initiated polyether polyol having ethylene oxide caps to provide the primary hydroxyl-termination. The ethylene oxide caps are typically present in the primary hydroxyl-terminated graft polyether polyol in an amount of from 5 to 20 parts by weight based on 100 parts by weight of Polyol C.

Polyol D is a tripropylene glycol-initiated conventional polyether polyol having ethylene oxide caps which provide primary hydroxyl groups. Polyol D has a weight average molecular weight of about 4,000 g/mol and a nominal functionality of 3. Polyol D has a hydroxyl number of about 35. The ethylene oxide caps are present in Polyol D in an amount of from 5 to 20 parts by weight based on 100 parts by weight of Polyol D.

Polyol E is a primary hydroxyl-terminated conventional triol containing an inhibitor package. Polyol E has a hydroxyl number of 25 mg KOH/g and a nominal functionality of 3.

Polyol F is a graft polyether polyol comprising Carrier Polyol Fl and particles of co-polymerized styrene and acrylonitrile. The particles of co-polymerized styrene and acrylonitrile are dispersed in Carrier Polyol Fl in an amount of greater than 25 parts by weight of particles based on 100 parts by weight of Carrier Polyol Fl. Polyol F has a hydroxyl number of less than 30 mg KOH/g and a viscosity of 2,950 cps at 25° C. Carrier Polyol Fl is a glycerine-initiated polyether polyol having ethylene oxide caps to provide the primary hydroxyl-termination. The ethylene oxide caps are present in Carrier Polyol Fl in an amount of from 5 to 20 parts by weight based on 100 parts by weight of Carrier Polyol Fl.

Crosslinker G is diethanolamine in water. The diethanolamine is present in Crosslinker G in an amount of about 85 parts by weight based on 100 parts by weight of Crosslinker G.

Crosslinker H has a functionality of <3 and a hydroxyl number of 860 mg KOH/g.

Solvent J is a liquid blowing agent.

Catalyst K is a 33% solution of triethylenediamine in dipropylene glycol.

Catalyst L is a 70% solution of bis(dimethylaminoethyl)ether in dipropylene glycol.

Catalyst M is a 50% solution of stannous octoate in dioctyl phthalate.

Catalyst N is dibutyltindilaurate.

Surfactant P is a polydimethylsiloxane-polyoxyalkylene block copolymer.

Blocking Agent Q is a polymeric acid that is reactive with isocyanate to form in-situ delayed action catalysts. Blocking Agent Q has a hydroxyl number of 210 mg KOH/g a specific gravity of 1.1 g/cm³ at 21° C., and an acid number of 140 mg KOH/g.

Flame Retardant Additive R is tris(1,3-dichloro-2-propyl)phosphate.

Each of the formulations of Examples 1-2 and Comparative Examples 3-5 is processed in a Cannon-Viking Maxfoam machine according to the processing conditions set forth in Table 2. The Cannon-Viking Maxfoam machine has a mechanical mixing head for mixing individual components, a trough for containing a flexible polyurethane foaming reaction, a conveyor for flexible polyurethane foam rise and cure, and a fallplate unit for leading expanding flexible polyurethane foam onto the moving conveyor.

Specifically, to form the flexible polyurethane foam of Examples 1 and 2, a first stream of Isocyanate A of the polyisocyanate composition is conveyed at a temperature of about 73° F. and a pressure of 805 psi to the mechanical mixing head. A second stream of the isocyanate-reactive composition of Examples 1 and 2 is also conveyed at a temperature of about 80° F. to the mechanical mixing head. The mechanical mixing head mixes the first stream and the second stream at a speed of 4,000 rpm to form reaction mixtures of Example 1 and Example 2. The reaction mixtures of Examples 1 and 2 are fed into the trough where the polyisocyanate composition and the isocyanate-reactive composition continue to react. The expanding flexible polyurethane foam passes from the top of the trough onto the fallplate unit. The fallplate unit leads the expanding flexible polyurethane foam onto and along the conveyor for completion of the flexible polyurethane foam rise and cure.

The flexible polyurethane foams of Comparative Examples 3-5 are prepared in the same manner. That is, the flexible polyurethane foams of Comparative Examples 3-5 are processed through the Cannon-Viking Maxfoam machine according to the processing conditions set forth in Table 2.

TABLE 2
Processing Conditions for Forming Flexible Polyurethane Foam

| | | | Comp. | Comp. | Comp. |
|---|---|---|---|---|---|
| Condition (unit) | Ex. 1 | Ex. 2 | Ex. 3 | Ex. 4 | Ex. 5 |
| Metered Amount (kg/min) | | | | | |
| Isocyanate A | 36.93 | 36.29 | — | — | — |
| Isocyanate B | — | — | 77.23 | 77.24 | 30.07 |
| Polyol C | 28.9 | 28.4 | 47.8 | 47.8 | — |
| Polyol D | 36.7 | 36.1 | 25.7 | — | 85.6 |
| Polyol E | — | — | — | 25.7 | — |
| Blend of Polyol D and Polyol F | — | — | — | — | 85.6 |
| Crosslinker G or H | 1.312 | 1.289 | 1.250 | 1.324 | 1.199 |
| Solvent J | 3.3 | 3.2 | — | — | — |
| Catalyst K | 0.098 | 0.097 | 0.103 | 0.118 | 0.137 |
| Catalyst L | 0.197 | 0.193 | 0.118 | 0.118 | 0.103 |
| Catalyst M | 0.082 | 0.081 | — | — | 0.283 |
| Catalyst N | — | — | 0.176 | 0.220 | — |
| Surfactant P | 0.656 | 0.644 | 0.883 | 0.956 | 0.856 |
| Blocking Agent Q | 0.066 | 0.066 | — | — | — |
| Water added | 1.856 | 1.823 | 2.111 | 2.104 | 1.713 |
| Flame Retardant Additive R | — | 0.851 | 1.434 | 1.435 | — |
| Processing Conditions | | | | | |
| Conveyor speed (fpm) | 10 | 10 | 12 | 12 | 12 |
| Isocyanate-reactive comp. temperature (° F.) | 73 | 73 | 494 | 491 | 68 |
| Polyisocyanate comp. temperature (° F.) | 80 | 80 | 78 | 79 | 80 |
| Room temperature (° F./Humid %/Atm) | 82/20/ | 82/20/ | 73/23/ | 73/23/ | n/a |
| | 29.6 | 29.6 | 29.4 | 29.4 | |
| Mixer speed (rpm) | 4,000 | 4,000 | 4,500 | 4,500 | 4,500 |
| N₂ gas pressure (psig) | 52.0 | 52.0 | 43 | 44 | n/a |
| N₂ gas flow rate (L/m) | 4.0 | 4.0 | 4.0 | 4.0 | 4.0 |
| Mechanical mixing head pressure (psig) | 17 | 17 | 24 | 24 | 22 |

The resulting flexible polyurethane foams of Examples 1-2 and Comparative Examples 3-5 are cured for 24-48 hours. The flexible polyurethane foams of Examples 1-2 and Comparative Examples 3-5 are then cut into 4″ thick samples for use in various tests to determine the values of various comfort and support, i.e., physical and fatigue, and flammability properties.

The samples are tested to determine a density at 68° C. and 50% relative humidity in accordance with ASTM D3574, a 25% indentation force deflection (IFD), and a support factor. The 25% IFD is defined as an amount of force in pounds required to indent a 50 in², round indentor foot into the sample a distance of 25% of the sample's thickness. Similarly, a 65% IFD is defined as the amount of force in pounds required to indent the indentor foot into the sample a distance of 65% of the sample's thickness. The support factor is the amount of force required to achieve 65% IFD divided by the amount of force required to achieve 25% IFD.

The samples are tested for tensile strength, elongation, and tear strength in accordance with ASTM D3574. Tensile strength, tear strength, and elongation properties describe the ability of the flexible polyurethane foam to withstand handling during manufacturing or assembly operations. Specifically, tensile strength is the force in lbs/in² required to stretch the flexible polyurethane foam to a breaking point. Tear strength is the measure of the force required to continue a tear in the flexible polyurethane foam after a split or break has been started, and is expressed in lbs/in (ppi). Tear strength values above 1.0 ppi are especially desirable for applications requiring the flexible polyurethane foam to be stapled, sewn, or tacked to a solid substrate, such as furniture or bedding which are comfort and support articles. Finally, elongation is a measure of the percent that the flexible polyurethane foam will stretch from an original length before breaking.

The resilience of the flexible polyurethane foams is measured in accordance with ASTM D3574 by dropping a steel ball from a reference height onto the samples and measuring a peak height of ball rebound. The peak height of ball rebound, expressed as a percentage of the reference height, is the resilience of the flexible polyurethane foam.

The flexible polyurethane foams of Examples 1-2 and Comparative Examples 3-5 are also tested for ability to withstand wear and tear, i.e., flex fatigue, according to ASTM D4065 by repeatedly compressing the flexible polyurethane foams and measuring a change in IFD. To measure flex fatigue, an original sample height is measured and an amount of force corresponding to 40% IFD for the sample is determined. The samples are then subjected to repeated pounding for 80,000 cycles at the 40% IFD force. After pounding, the sample height and the 40% IFD force are then re-measured and a percentage of height loss and hardness loss are calculated.

The flexible polyurethane foams of Examples 1-2 and Comparative Examples 3-5 are also evaluated for static fatigue, compression set, and compression force deflection (CFD), each in accordance with ASTM D3574. Static fatigue is a measure of a loss in load-bearing performance of the flexible polyurethane foam. Static fatigue is measured by subjecting the flexible polyurethane foam to a constant compression of 75% of the original height of the sample for 17 hours at room temperature. Next, compression set is a measure of permanent partial loss of original height of the flexible polyurethane foam after compression due to a bending or collapse of cellular structures within the flexible polyurethane foam. Compression set is measured by compressing the flexible polyurethane foam by 90%, i.e., to 10% of original thickness, and holding the flexible polyurethane foam under such compression at 70° C. for 22 hours. Compression set is expressed as a percentage of original compression. Finally, CFD is a measure of load-bearing performance of the flexible polyurethane foam and is measured by compressing the flexible polyurethane foam with a flat compression foot that is larger than the sample. CFD is the amount of force exerted by the flat compression foot and is typically expressed at 25%, 40%, 50%, and/or 65% compression of the flexible polyurethane foam.

Additionally, the flexible polyurethane foams of Examples 1-2 and Comparative Examples 3-5 are also subject to humid aging for compression set and CFD, and heat aging for tensile strength and elongation according to ASTM D3547. Humid aging is an accelerated aging test method under conditions of 220° F. for 3 hours at 100% relative humidity. Heat aging is an accelerated aging test method under conditions of 220° F. for 3 hours. Test results for heat aged flexible polyurethane foam are denoted HTAG in Table 3.

Further, the samples are measured for porosity according to the air flow test of ASTM D2574. The air flow test measures the ease with which air passes through the flexible polyurethane foams. The air flow test consists of placing a sample in a cavity over a chamber and creating a specified constant air-pressure differential. The air-flow value is the rate of air flow, in cubic feet per minute, required to maintain the constant air-pressure differential. Said differently, the air flow value is the volume of air per second at standard temperature and pressure required to maintain a constant air-pressure differential of 125 Pa across a 2″×2″×1″ sample.

Importantly, the samples are also evaluated for flammability after experiencing flex fatigue. Each sample is tested to determine compliance with the California Technical Bulletin 117 Section A and Section D requirements, i.e., the Vertical Open Flame test and the Cigarette Resistance and Smoldering Screening tests. Specifically, the Vertical Open Flame test measures an amount of time that the samples exhibit a flame after an open flame is removed, i.e., an afterflame time. For the Vertical Open Flame test, the samples are suspended vertically 0.75 inches above a burner and a flame is applied vertically at the middle of a lower edge of the samples for 12 seconds. The results of the Vertical Open Flame test are recorded as a char length, i.e., a distance from the flame-exposed end of the sample to an upper edge of a resulting void area. The vertical open flame test is performed on original and heat aged conditioned foam samples.

The Cigarette Resistance and Smoldering Screening tests measure a resistance of the flexible polyurethane foam to burning and smoldering as well as cigarette ignition. For both the Cigarette Resistance and Smoldering Screening tests, each sample is conditioned for at least 24 hours at 70±5° F. and less than 55% relative humidity prior to testing.

For the Smoldering Screening test, foam samples are tested both before and after experiencing flex fatigue. To establish reference values before the samples experience flex fatigue, each sample of the flexible polyurethane foam is weighed and a pre-test weight is recorded. The sample is arranged in an L-shaped configuration, i.e., a horizontal portion of the sample is disposed adjacent to and in contact with a vertical portion of the sample. A lit cigarette is placed adjacent to and in contact with both the horizontal portion and vertical portion of the sample, and the sample and lit cigarette are covered with cotton or cotton/polyester bed sheeting material. The lit cigarette is allowed to smolder until all evidence of combustion has ceased for at least 5 minutes. After combustion has ceased, the non-burned portions of the samples are weighed and compared to the pre-test weights to determine the percent of non-smoldered flexible polyurethane foam. The results are recorded as % weight retained before pounding fatigue in Table 3.

To evaluate the cigarette smoldering resistance of the flexible polyurethane foam after the samples have experienced flex fatigue, the samples are first subjected to repeated pounding for 80,000 cycles at the 40% IFD force, each sample of the flexible polyurethane foam is weighed, and a pre-test after-flex fatigue weight is recorded. The Smoldering Screening test is then conducted as set forth above. After combustion has ceased, the non-burned portions of the samples are weighed and compared to the pre-test after-flex fatigue weights to determine the percent of non-smoldered flexible polyurethane foam. The results are recorded as % weight retained after pounding fatigue in Table 3.

A summary of the values of the physical, fatigue, and flammability properties of the flexible polyurethane foams of Examples 1-2 and Comparative Examples 3-5 is set forth in Table 3.

TABLE 3
Physical, Fatigue, and Flammability Properties of Flexible Polyurethane Foam

| | | | Comp. | Comp. | Comp. |
|---|---|---|---|---|---|
| Property (unit) | Ex. 1 | Ex. 2 | Ex. 3 | Ex. 4 | Ex. 5 |
| Physical Properties | | | | | |
| Density (pcf) | 1.73 | 1.77 | 1.68 | 1.71 | 2.15 |
| Elongation (%) | 110 | 110 | 137 | 140 | 122 |
| Tensile strength (psi) | 17 | 16 | 22 | 23 | 22 |
| HTAG Elongation (%) | 105 | 106 | 145 | 152 | 125 |
| HTAG Tensile strength (psi) | 16 | 15 | 23 | 24 | 22 |
| Tear strength (ppi) | 1.6 | 1.5 | 2.3 | 2.6 | 2.1 |
| Resilience (%) | 51 | 51 | 53 | 55 | 64 |
| IFD (lb/50 in²) | | | | | |
| 25% | 21 | 22 | 32 | 29 | 30 |
| 65% | 52 | 54 | 70 | 65 | 72 |
| 25% return | 15 | 16 | 23 | 21 | 25 |
| Support factor | 2.51 | 2.44 | 2.19 | 2.24 | 2.41 |
| Compression sets (% set) | | | | | |
| 50% | 12 | 9 | 4 | 5 | 3 |
| 50% humid aged | 13 | 11 | 8 | 9 | 4 |
| CFD, humid aged (% of original 50%) | 93 | 94 | 100 | 99 | 100 |
| Air flow (cfm) | 0.9 | 1.0 | 0.7 | 1.1 | 1.4 |
| Fatigue Properties | | | | | |
| Static Fatigue | | | | | |
| Height, % loss | 4.9 | 4.2 | 2.8 | 3.0 | 1.7 |
| IFD, 25% loss | 27 | 26 | 22 | 21 | 13 |
| IFD, 65% loss | 23 | 22 | 20 | 20 | 13 |
| Pounding, 80,000 cycles | | | | | |
| Height, % loss | 3.2 | 3.2 | 2.1 | 2.5 | 1.4 |
| 40% IFD, % loss | 29 | 32 | 27 | 26 | 17 |
| Flammability Properties | | | | | |
| Cal. T.B. 117 Vertical Open Flame | Pass | Pass | Pass | Pass | Fail |
| Afterflame (sec., avg.) | 0.0 | 0.0 | 0.0 | 0.3 | 25.0 |
| Char length (in., avg.) | 2.7 | 2.2 | 3.2 | 2.8 | 12.0 |
| Afterflame HTAG (sec., avg.) | 0.0 | 0.0 | 0.3 | 0.0 | n/a |
| Char length HTAG (in., avg.) | 2.2 | 1.8 | 3.2 | 3.5 | n/a |
| Cal. T.B. 117 Smoldering | Pass | Pass | Pass | Fail | Pass |
| % wt retained before pounding fatigue | 99.4 | 98.7 | 98.0 | 72.8 | 96.2 |
| % wt retained after pounding fatigue | 99.7 | 99.3 | 84.4 | 68.8 | n/a |

The flexible polyurethane foams of Example 1 and Example 2 comprise identical formulations, with the notable exception that the formulation of Example 2 includes a flame retardant additive while the formulation of Example 1 is free from flame retardant additives. Further, the flexible polyurethane foams of Example 1 and Example 2 exhibit identical height percentage loss when subjected to a pounding of 80,000 cycles. Unexpectedly, however, the flexible polyurethane foam of Example 1 exhibits flame retardance under flammability tests according to California Technical Bulletin 117 regulations irrespective of an amount of flex fatigue of the flexible polyurethane foam of Example 1 even without inclusion of flame retardant additives. Moreover, since the flexible polyurethane foam of Example 1 is free from flame retardant additives, the flexible polyurethane foam is cost effective to manufacture.

In contrast, the flexible polyurethane foam of Comparative Example 4 fails the Cigarette Resistance and Smoldering Screening tests of California Technical Bulletin 117, even though the flexible polyurethane foam of Comparative Example 4 includes a flame retardant additive. In contrast, the flexible polyurethane foams of Example 1, Example 2, Comparative Example 3, and Comparative Example 5 all pass the Cigarette Resistance and Smoldering Screening test of California Technical Bulletin 117. By reference to Table 1, the flexible polyurethane foams of Example 1, Example 2, Comparative Example 3, and Comparative Example 5 all comprise Polyol D, whereas the flexible polyurethane foam of Comparative Example 4 excludes Polyol D. More specifically, the flexible polyurethane foams of Example 1, Example 2, and Comparative Example 3 all comprise Polyol C and Polyol D, whereas the flexible polyurethane foam of Comparative Example 4 excludes Polyol D. Therefore, without intending to be limited by any particular theory, it is believed that the second polyol, Polyol D, of the flexible polyurethane foams of Examples 1-2 and Comparative Examples 3 and 5 contributes to the flame retardance of the flexible polyurethane foams.

Similarly, the flexible polyurethane foam of Comparative Example 5 fails the Vertical Open Flame test of California Technical Bulletin 117. As set forth above, the flexible polyurethane foam of Comparative Example 5 also is free from flame retardant additives. Conversely, the flexible polyurethane foams of Examples 1-2 and Comparative Examples 3-4 all pass the Vertical Open Flame test of California Technical Bulletin 117. With reference to Table 1, the flexible polyurethane foams of Examples 1-2 and Comparative Examples 3-4 all comprise Polyol C, whereas the flexible polyurethane foam of Comparative Example 5 excludes Polyol C. Therefore, without intending to be limited by theory, it is believed that the primary hydroxyl-terminated graft polyether polyol, Polyol C, of the flexible polyurethane foams of Examples 1-2 and Comparative Examples 3-4 contributes to the flame retardance of the flexible polyurethane foams.

Finally, of the three samples that exhibit flame retardance regardless of the amount of flex fatigue of the flexible polyurethane foam and therefore pass both the Vertical Open Flame and Cigarette Resistance and Smoldering Screening tests of California Technical Bulletin 117, i.e., Example 1, Example 2, and Comparative Example 3, only the flexible polyurethane foam of Example 1 exhibits flame retardance with a formulation that is free from both flame retardant additives and TDI. That is, unexpectedly, the flexible polyurethane foam of Example 1 exhibits flame retardance under flammability tests according to California Technical Bulletin 117 regulations irrespective of an amount of flex fatigue of the flexible polyurethane foam and does not include a flame retardant additive or TDI. Rather, the flexible polyurethane foam of Example 1 exhibits flame retardance and is formed from a formulation comprising MDI. As TDI is typically less desirable than MDI, the polyisocyanate composition of Example 1 exhibits more acceptable processing characteristics as compared to existing polyisocyanate compositions comprising TDI. Yet, the flexible polyurethane foam of Example 1 exhibits flame retardance under flammability tests according to California Technical Bulletin 117 regulations irrespective of an amount of flex fatigue of the flexible polyurethane foam.

In particular, even when experiencing flex fatigue, which compromises the cellular structure of flexible polyurethane foam, allows for increased oxygen circulation within the foam, and typically increases the flammability of flexible polyurethane foam, the flexible polyurethane foam of Example 1 unexpectedly exhibits flame retardance irrespective of an amount of flex fatigue of the flexible polyurethane foam. Only the flexible polyurethane foam of Example 1 retains greater than 99% of its weight both before and after experiencing flex fatigue, and passes the Vertical Open Flame and Cigarette Resistance and Smoldering Screening tests. Even after repeated flex fatigue, the flexible polyurethane foam of Example 1 exhibits flame retardance, without inclusion of a conventional flame retardant additive in the formulation of Example 1. It is believed that the inclusion of the polymeric MDI and the monomeric MDI in the quantities set forth above, rather than TDI which is conventionally used to impart flame retardance to flexible polyurethane foams, in combination with the primary hydroxyl-terminated graft polyether polyol and the second polyol, both having the weight average molecular weights set forth above, unexpectedly provides the flexible polyurethane foam with flame retardance irrespective of an amount of flex fatigue.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

What is claimed is:

1. A flexible polyurethane foam having a density of less than 100 kg/m ³ and comprising a reaction product of:
a polyisocyanate composition comprising;
a polymeric diphenylmethane diisocyanate (MDI) component; and
a monomeric diphenylmethane disocyanate (MDI) component comprising 2,4′-MDI;
wherein said 2,4′-MDI is present in said monomeric MDI component in an amount greater than 35 parts by weight of said 2,4′-MDI based on 100 parts by weight of said monomeric MDI component; and
an isocyanate-re active composition comprising;
a primary hydroxyl-terminated graft polyether polyol comprising a carrier polyol and particles of co-polymerized styrene and acrylonitrile dispersed in said carrier polyol, wherein said carrier polyol has a weight average molecular weight of greater than or equal to 3,500 g/mol; and
a second polyol different from said primary hydroxyl-terminated graft polyether polyol;
wherein said flexible polyurethane foam exhibits flame retardance under flammability tests according to California Technical Bulletin 117 regulations irrespective of an amount of flex fatigue of said flexible polyurethane foam.

2. A flexible polyurethane foam as set forth in claim 1 free from flame retardant additives.

3. A flexible polyurethane foam as set forth in claim 1 wherein said carrier polyol of said primary hydroxyl-terminated graft polyether polyol has a weight average molecular weight of greater than or equal to 3,500 g/mol.

4. A flexible polyurethane foam as set forth in claim 3 wherein said carrier polyol of said primary hydroxyl-terminated graft polyether polyol has a weight average molecular weight of greater than or equal to 4,000 g/mol.

5. A flexible polyurethane foam as set forth in claim 4 wherein said second polyol has a weight average molecular weight of greater than or equal to 5,000 g/mol.

6. A flexible polyurethane foam as set forth in claim 5 wherein said particles of co-polymerized styrene and acrylonitrile are dispersed in said carrier polyol in an amount of from 5 to 65 parts by weight of particles based on 100 parts by weight of said carrier polyol.

7. A flexible polyurethane foam as set forth in claim 6 wherein said particles of co-polymerized styrene and acrylonitrile are dispersed in said carrier polyol in an amount of from 10 to 45 parts by weight of particles based on 100 parts by weight of said carrier polyol.

8. A flexible polyurethane foam as set forth in claim 1 wherein said second polyol has a weight average molecular weight of greater than or equal to 1,000 g/mol.

9. A flexible polyurethane foam as set forth in claim 8 wherein said second polyol has a weight average molecular weight of greater than or equal to 3,500 g/mol.

10. A flexible polyurethane foam as set forth in claim 9 wherein said second polyol has a weight average molecular weight of greater than or equal to 4,000 g/mol.

11. A flexible polyurethane foam as set forth in claim 1 wherein said isocyanate-reactive composition further comprises a crosslinker having a nominal functionality of less than 4.

12. A flexible polyurethane foam as set forth in claim 11 wherein said crosslinker is diethanolamine.

13. A flexible polyurethane foam as set forth in claim 1 wherein said primary hydroxyl-terminated graft polyether polyol is present in said isocyanate-reactive composition in an amount of from 5 to 95 parts by weight based on 100 parts of total polyol present in said isocyanate-reactive composition.

14. A flexible polyurethane foam as set forth in claim 13 wherein said primary hydroxyl-terminated graft polyether polyol is present in said isocyanate-reactive composition in an amount of 10 to 90 parts by weight based on 100 parts of total polyol present in said isocyanate-reactive composition.

15. A flexible polyurethane foam as set forth in claim 1 wherein said isocyanate-reactive composition further comprises a catalyst component.

16. A method of forming a flexible polyurethane foam, said method comprising the steps of:
providing a polyisocyanate composition comprising;
a polymeric diphenylmethane diisocyanate (MDI) component; and
a monomeric diphenylmethane diisocyanate (MDI) component comprising 2,4′-MDI;
wherein the 2,4′-MDI is present in the monomeric MDI component in an amount greater than 35 parts by weight of the 2,4′-MDI based on 100 parts by weight of the monomeric MDI component;
providing an isocyanate-reactive composition comprising;
a primary hydroxyl-terminated graft polyether polyol comprising a carrier polyol and particles of co-polymerized styrene and acrylonitrile dispersed in the carrier polyol, wherein the carrier polyol has a weight average molecular weight of greater than or equal to 3,500 g/mol;
a second polyol different from the primary hydroxyl-terminated graft polyether polyol; and
reacting the polyisocyanate composition with the isocyanate-reactive composition to form the flexible polyurethane foam;
wherein the flexible polyurethane foam exhibits flame retardance under a flammability test according to California Technical Bulletin 117 regulations irrespective of an amount of flex fatigue of the flexible polyurethane foam.

17. The method as set forth in claim 16 wherein the flexible polyurethane foam is free from flame retardant additives.

18. The method as set forth in claim 16 wherein the flexible polyurethane foam is formed along a slabstock conveyor system.

19. The method as set forth in claim 16 wherein the carrier polyol has a weight average molecular weight of greater than or equal to 4,000 g/mol.

20. The method as set forth in claim 19 wherein the particles of co-polymerized styrene and acrylonitrile are dispersed in the carrier polyol in an amount of from 10 to 45 parts by weight of particles based on 100 parts by weight of the carrier polyol.

21. The method as set forth in claim 19 wherein the carrier polyol has a weight average molecular weight of greater than or equal to 5,000 g/mol.

22. The method as set forth in claim 21 wherein the second polyol has a weight average molecular weight of greater than or equal to 4,000 g/mol.

23. The method as set forth in claim 16 wherein the second polyol has a weight average molecular weight of greater than or equal to 4,000 g/mol.

24. The method as set forth in claim 16 wherein the particles of co-polymerized styrene and acrylonitrile are dispersed in the carrier polyol in an amount of from 10 to 45 parts by weight of particles based on 100 parts by weight of the carrier polyol.

25. The method as set forth in claim 16 wherein the isocyanate-reactive composition further comprises a crosslinker having a nominal functionality of less than 4.

26. The method as set forth in claim 25 wherein the crosslinker is diethanolamine.

27. The method as set forth in claim 16 wherein the primary hydroxyl-terminated graft polyether polyol is present in the isocyanate-reactive composition in an amount of 5 to 95 parts by weight based on 100 parts of total polyol present in the isocyanate-reactive composition.

28. The method as set forth in claim 16 wherein the step of reacting the polyisocyanate composition with the isocyanate-reactive composition occurs in the presence of a catalyst component to form the flexible polyurethane foam.
